(19) United States
(12) Patent Application Publication
(10) Pub. No.: US 2004/0192312 A1
(43) Pub. Date: Sep. 30, 2004

(54) Communication system for voice and data with wireless TCP server

(76) Inventors: Jia-Ru Li, Aliso Viejo, CA (US); Fan Zhang, Aliso Viejo, CA (US); Xiaodong Chen, Aliso Viejo, CA (US); Kueihsien Tseng, Aliso Viejo, CA (US); Sang-Ho Park, Kwangju City (KR)

Correspondence Address: KNOBBE MARTENS OLSON & BEAR LLP, 2040 MAIN STREET, FOURTEENTH FLOOR, IRVINE, CA, 92614, US

(21) Appl. No.: 10/198,057

(22) Filed: Jul. 16, 2002

(51) Int. Cl. H04Q 7/20

(52) U.S. Cl. 455/445; 455/426.1

(57) ABSTRACT

A wireless communication system is structured to a have a first branch and a second branch. The first branch is configured for communications between a wireless terminal and a telecommunication device coupled to a PSTN. The second branch is configured for data communications between the wireless terminal and a host server coupled to the Internet. The second branch includes a PDSN coupled to receive data signals from the wireless terminal and to send data signals to the wireless terminal, a router coupled to the Internet, and a server coupled between the router and the PDSN. The server is configured to translate a first transmission protocol used for communications over the Internet to a second transmission protocol used for communications with the wireless terminal.

### BACKGROUND OF THE INVENTION

1. Field of the Invention

The present invention relates to mobile communication systems for voice and data transmission. More particularly, the present invention relates to a protocol server for data transmission and a method of transmitting data using the protocol server.

2. Description of the Related Technology

Increasingly, mobile communication systems based on GSM or CDMA technology enable users not only to talk to other users, but also to send and receive data. For example, using a mobile terminal, a user can send and receive short messages using the Short Messaging Service (“SMS”), or access Internet content and view the content on the terminal's display. For example, a Web server sends the requested content via the Internet to the user's terminal using the wireless application protocol (“WAP”) that formats Internet content for display on the mobile terminal. SMS and WAP are compatible with a data transmission service in accordance with the general packet radio service (“GPRS”) technology. The CDMA 2000 technology allows high-speed access to Internet content via mobile terminal. The GPRS and the CDMA 2000 technologies send data using packet switched transmission and industry-standard data protocols or a transmission control protocol (“TCP”) used along with the Internet protocol (“IP”).

TCP and IP send data in form of message units between computers over the Internet. While the IP handles the actual delivery of the data, the TCP keeps track of the individual data packet a message is divided into for efficient routing through the Internet. For example, when an HTML file is sent from a host Web server, the TCP program layer in the Web server divides the file into one or more packets, numbers the packets, and then forwards the packets individually to the IP program layer. Although each packet has the same destination IP address, the packets may get routed differently through the network. At the client end, the TCP reassembles the individual packets and waits until each packet has arrived to forward the packets as a single file. TCP is a connection-oriented protocol assigned to the transport layer (layer 4) in the Open Systems Interconnection (OSI) communication model. Among others, the TCP provides for connection oriented, stream-like delivery, flow control and congestion control.

Line transmission networks and wireless networks apply different operational concepts. A wired network assumes a constant connection with high bandwidth and increasingly faster transmission speed. A wireless network operates via intermittent connections over a narrow bandwidth channel that operates at much slower speeds. Further, line transmission networks and wireless networks approach packet data loss differently. The line transmission network attributes a packet data loss to congestion and, thus, reduces data throughput. The wireless network, however, attributes a packet data loss to loss occurring during air transmission and, thus, resends the packet rather than decreasing data throughput. These fundamental differences introduce a number of difficulties when traditional “wired” applications are applied to wireless networks.

There is therefore a need for an improved mobile communication system and an improved method of transmitting data in the communications system so that TCP/IP-based applications (browsers, FTP, email and custom-developed IP applications) run seamlessly, reliably and efficiently over networks without modifications to the applications.

### SUMMARY OF CERTAIN INVENTIVE ASPECTS

In accordance with one inventive aspect, a wireless communication system is structured to a have a first branch and a second branch. The first branch is configured for communications between a wireless terminal and a telecommunication device coupled to a first network. The second branch is configured for data communications between the wireless terminal and a host server coupled to a second network. The second branch includes a first network element coupled to receive data signals from the wireless terminal and to send data signals to the wireless terminal, a router coupled to the second network, and a server coupled between the router and the first network element. The server is configured to translate a first transmission protocol used for communications over the second network to a second transmission protocol used for communications with the wireless terminal.

A further inventive aspect relates to a method of transmitting data signals between a wireless terminal and a host server coupled to the Internet. Data is received at a server interposed between a router coupled to the Internet and a first network element coupled to communicate with a wireless terminal. Upon receipt of data sent by the router, a first transmission protocol used for communications over the Internet is translated to a second transmission protocol used for communications with the wireless terminal. Upon receipt of data sent by the first network element, the second transmission protocol is translated to the first transmission protocol.

Another inventive aspect relates to a method of transmitting data signals between a wireless terminal and a host server coupled to the Internet. Data is sent from a host server via the Internet to a router using a first communications protocol, and forwarded from the router to a server coupled between the router and a first network element. A first transmission protocol used for communications over the second network is translated to a second transmission protocol used for communications with the wireless terminal.

### BRIEF DESCRIPTION OF THE DRAWINGS

These and other aspects, advantages, and novel features of the invention will become apparent upon reading the following detailed description and upon reference to the accompanying drawings. In the drawings, same elements have the same reference numerals.

FIG. 1 shows a schematic illustration of one embodiment of mobile communication system for voice and data communications.

FIG. 2 is a schematic, functional block diagram of one embodiment of the system of FIG. 1 illustrating the protocol functionality of the system.

FIG. 3 illustrates one embodiment of an algorithm that provides for fast retransmit and fast recovery.

FIG. 4 illustrates one embodiment of an algorithm that increases the size of an initial window.

FIG. 5 is an exemplary illustration of an algorithm that provides for explicit congestion notification.

FIG. 6 is an exemplary illustration of a compressed packet format.

FIG. 7 illustrates one embodiment of an algorithm that provides for a compression of a header.

FIG. 8 is an illustration of one embodiment of a delayed duplicate acknowledgement scheme.

FIG. 9 is another illustration of one embodiment of a delayed duplicate acknowledgement scheme between a sender and a receiver.

FIG. 10 is an illustration of one embodiment of a TCP control block interdependence for use in a new connection.

FIG. 11 is an illustration of an algorithm that provides for active queue management.

FIG. 12 is an illustration of an algorithm that provides for selective acknowledgement between a sender and a receiver.

FIG. 13 is an illustration of a Snoop protocol implemented in one embodiment of the system of FIG. 1.

FIG. 14 is a schematic illustration of a class-based queuing in one embodiment of the system of FIG. 1.

FIG. 15A is a graph illustrating a conventional slow start and congestion avoidance procedure.

FIG. 15B is a graph illustrating one embodiment of a modified slow start and congestion avoidance procedure.

### DETAILED DESCRIPTION OF CERTAIN INVENTIVE EMBODIMENTS

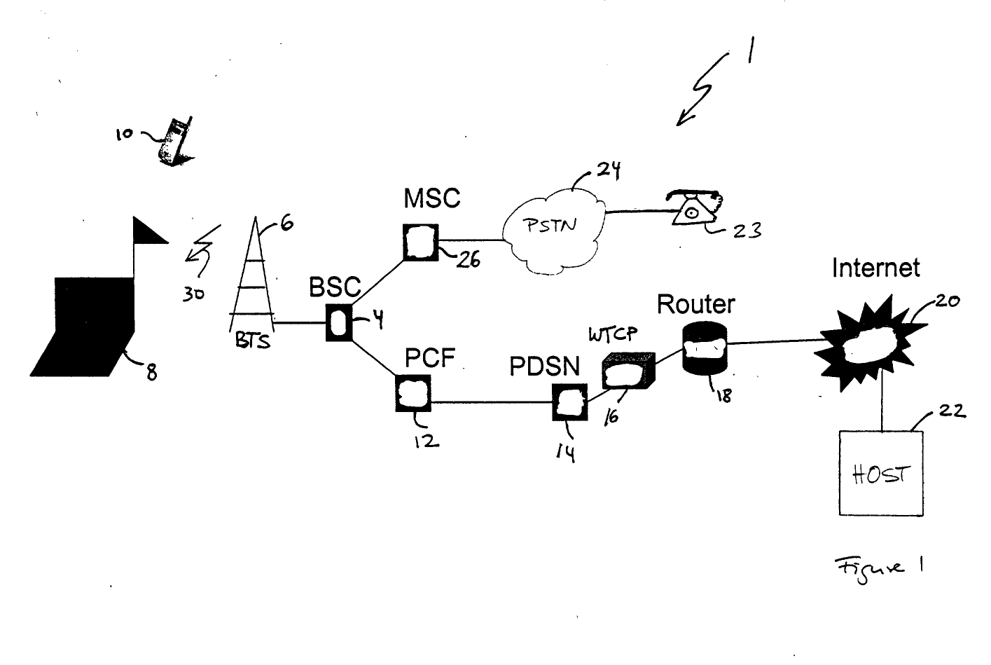

FIG. 1 is an illustration of one embodiment of a mobile communication system 1 for voice and data communications. The system 1 includes a plurality of mobile terminals, such as mobile phones 10, handheld personal digital assistants (PDAs) with radio capability, and mobile computers 8 with radio capability. Mobile subscribers can use the mobile terminals to communicate (i.e., talk and exchange data) with other mobile subscribers within the system 1, or with fixed-line telecommunication devices 23 coupled, for example, to the public switched telephone network 24 (PSTN). The mobile subscribers can further use the mobile terminals to access a global communications network, for example, the Internet 20 to view content provided by a host server 22. The Internet 20 allows the user to access information available on the World Wide Web (WWW). Without any limitation, the terms “Internet” and “World Wide Web” are hereinafter used to refer to the functions of interconnected computers and computer networks that provide for communications and access to information. Thus, it is contemplated that the inventive aspects apply to any Internet-like network, regardless of the particular terms used.

Those skilled in the art will appreciate that the system 1 may operate in accordance with one of several communications technologies. For example, the system 1 may in one embodiment operate in accordance with the CDMA 2000 technology. The CDMA 2000 technology is described, for example, in The CDMA Development Group webpage, Advanced Systems—Third Generation CDMA Systems Applicable to IMT-2000, http://www.cdg.org/tech/tech_ref.aspVer0.09, Nov. 17, 1997. In another embodiment, the system 1 may operate in accordance with the GPRS technology. The GPRS technology is described, for example, in [Bettstetter, 99] C. Bettstetter, H-J Voegel, J Eberspaecher (Technische Universitaet Muenchen (TUM)). GSM Phase 2+ General Packet Radio Service GPRS: Architecture, Protocols And Air Interface from IEEE Communications Surveys, Third Quarter 1999, vol.2 no.3. Hereinafter, one embodiment of the system 1 is described with reference to the CDMA 2000 technology. Accordingly, the description and the drawings use terminology based on the CDMA 2000 technology.

The system 1 includes a branch that has a base transceiver station 6 (BTS), a base station controller 4 (BSC) and a mobile switching center 26 (MSC) that is coupled to the PSTN 24. The BTS 6, the BSC 4 and the MSC 26 provide for communications between the mobile subscribers and fixed-line subscribers, as is known in the art. It is contemplated that more than one BTS is typically coupled to a BSC, and that more than one BSC is typically coupled to a MSC.

Further, the system 1 includes a branch that permits the mobile subscribers to access the Internet 20. This branch includes a node 12 coupled to the BSC 4 and performing a packet carrying function (hereinafter referred to as PCF node 12), a packet data serving node 14 (PDSN) coupled to the PCF node 12, and a router 18 coupled to the Internet 20. The branch includes further a server 16 interconnected between the PDSN node 14 and the router 18. The characteristics of the PCF node 12, the PDSN node 14 and the router 18 are described in 3GPP2 Specifications, Interoperability Specification (IOS) for CDMA 2000 Access Network Interfaces —Part 1 Overview (271KB), http://www.3gpp2.org/Public_html/specs/A.S0011-0_v1.0.pdf.

As illustrated in FIG. 1, the system 1 includes the server 16 as a protocol interface. Accordingly, the branch between the BSC 4 and the Internet 20 includes a “subscriber-side section” extending between the server 16 and the BSC 4, and a “host-side section” extending between the server 16 and the Internet 20. The server 16 uses a wireless TCP (“WTCP”) for communications with the mobile terminals. For communications with the host server 22, the server 16 uses the TCP. The server 16 is configured to “translate” or to “convert” the TCP to the WTCP, and vice versa. The server 16 is hereinafter referred to as WTCP server 16. Using the TCP for communications with the host server 22, the WTCP server 16 ensures Internet-wide compatibility.

The system 1 with the WTCP server 16 in the data branch provides for improved overall network performance. For example, using the WTCP server 16 in the data branch of the system 1 remotely located from the mobile terminals improves the bandwidth performance of signals to a mobile terminal by about 20%-35%. The mobile subscribers experience, among others, a faster access to and download of the selected Internet content. The system 1 enables service providers to offer additional applications that require more bandwidth, such as audio and video applications, file transfers (FTP) and custom-developed IP applications, and email services. The system 1 shows also less data failures and less session time-outs than conventional systems that improves the reliability and efficiency of the system 1. Further, the system 1 permits that one BTS can serve a higher number of mobile terminals, and improves the communication efficiency of the individual mobile terminals.

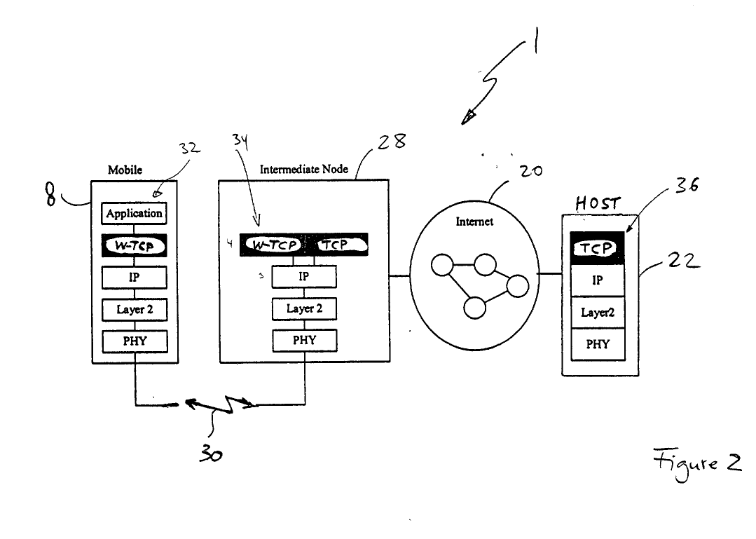

FIG. 2 is an illustration of the system 1 to depict the protocol functionality of the system 1. For ease of illustration, an intermediate node 28 represents a software functionality implemented in the WTCP server 16. The intermediate node 28 communicates with the host server 22 via the Internet 20 and with the mobile terminal 8 via a radio connection 30. The mobile terminal 8 is configured to run “local” WTCP software, the intermediate node 28 is configured to run “local” WTCP and TCP software, and the host server 22 is configured to run “local” TCP software. For illustrative purposes, FIG. 2 shows the respective WTCP and TCP software in the layer structure of the ISO Open System Interconnection—Reference Model (OSI-RM).

The system 1 uses a transmission control protocol that is based on the transmission control protocol (TCP) for transmitting data between a mobile terminal and the host server 22. As is known in the art, the TCP is a standard, connection-oriented, full-duplex, host-to-host protocol used over packet-switched communications network. The TCP corresponds closely to the transport layer (Layer 4) of the OSI-RM. The OSI-RM is an abstract description of the digital communications between application processes and employs a hierarchical structure of seven layers. Each layer performs value-added service at the request of the adjacent higher layer and, in turn, requests more basic services from the adjacent lower layer.

### ISO Open System Interconnection—Reference Model (OSI-RM)

Briefly, the physical layer (Layer 1) is the lowest layer and, among others, establishes and terminates a connection to a communication medium, and participates in the process of sharing resources among multiple users, such as flow control. The data link layer (Layer 2) responds to service requests from the higher network layer (Layer 3) and provides the functional and procedural means to transfer data between network entities. The data link layer also detects and possibly corrects errors that may occur in the physical layer. The network layer (Layer 3) provides the functional and procedural means of transferring variable length data sequences from a source to a destination via one or more networks while maintaining the quality of service (QoS) requested by the higher transport layer (Layer 4). Among others, the network layer performs network routing, flow control, segmentation and desegmentation, and error control functions. The transport layer (Layer 4) provides for a transparent transfer of data between end users and relieves higher layers from providing reliable and cost-effective data transfer. The session layer (Layer 5) provides the mechanism for managing the dialogue between end-user application processes, and provides for either duplex or half-duplex operation and establishes checkpointing, adjournment, termination, and restart procedures. The presentation layer (Layer 6) responds to service requests from the higher application layer (Layer 7) and handles syntactical differences in data representation within the end-user systems. The application layer (Layer 7) is the highest layer and interfaces directly to and performs common application services for the application processes, and issues requests to the lower presentation layer. The common application services provide semantic conversion between associated application processes.

### Transfer Control Protocol (TCP)

The OSI-RM layer structure in mind, the TCP of Layer 4 is briefly described to the extent believed to be helpful to fully appreciate the operation of the system 1. As a connection-oriented protocol TCP opens a connection to deliver messages, and establishes a context for these messages. The TCP can relate different messages with each other, identify the sequence of individual messages, identify duplicate messages, and determine when particular messages are missing. Further, the TCP uses socket pairs to identify individual connections and to identify the endpoints of a connection. A socket includes an IP address, which identifies a particular system (e.g., the webserver 22), and a port value, which distinguishes different application protocols within that system. A pair of sockets can uniquely identify a connection since every connection has two endpoints.

The TCP uses a three-way handshake. For example, a server's application initiates a passive connection request for the local TCP indicating that the application can accept connections. A client computer application triggers its local TCP to initiate an active connection request to establish a connection (for example, to make a call) to the application at the remote server. The local TCP software on the client computer sends a TCP connect request to the server and the workstation. The server's TCP software receives the TCP connect request, and since the requested application is in the listening mode, the TCP responds back to the sender with a TCP connect response to positively confirm the request. The client computer TCP software receives the TCP connect response, and is certain that the connection is established. The TCP software in the server is not as certain because, although the response was sent back, there is no assurance that the response has made it back successfully to the client computer. The TCP software in the client computer then sends a TCP acknowledgement to the server that explicitly acknowledges the receipt of the TCP connect response.

The TCP transfers data over the established connection by packaging that data in a TCP message. The data is a sequence of bytes divided into sequentially numbered segments for transmission, wherein each segment is transferred across the network embedded in a single IP packet. When the TCP messages arrive at the destination, the TCP software at the receiving site uses the sequence numbers to reconstruct the correct order of the data. If segments are received with the same sequence number, the TCP software recognizes that segments are duplicated and discards the extra duplicate copies. If there is a gap in the sequence numbers of the received segments, the TCP software recognizes that segments are missing and may recover the missing data by requesting the sender to send a new copy of the missing data. Using an acknowledgement mechanism, the TCP software includes an acknowledgement number that serves as a message to the remote sender that all data up to, but not including, the data byte with this sequence number has been received.

The TCP uses the sequence numbers for flow control to adjust the data transmission rate to the receiver's ability to receive the data, for example, to avoid data overflow. Each side of a TCP connection indicates to the remote end how much data it can accept by specifying a window size, for example, an advertise window size of 300 bytes, included in the acknowledgement segment.

Upon a request to close a connection from an application at one end of the connection, the local TCP sends to the remote TCP a TCP close indication message. The remote end acknowledges that it has received the request by sending a TCP acknowledgement message. At this point, the data flow stops in one direction. However, the connection is not completely closed until the application program at the remote server requests from its local TCP to close it. The above exchange of TCP close indication and TCP acknowledgement messages is repeated, in the opposite direction, i.e., the TCP at the server sends a TCP close indication message and the TCP at the computer responds with a TCP acknowledgement message. After this exchange, the TCP has stopped the data flow in both directions.

For a transmission over a network, the TCP packs a segment in an IP packet and in a frame. The TCP segment may traverse several networks between a sender and a receiver. Examples of such networks are Ethernet LAN, ATM networks, Frame Relay networks, to name a few.

As to the formatting, the source port and destination port fields specify the port values for the transmitter and the receiver, respectively. The sequence number field is 32-bit long. In a TCP segment, where the SYN bit in the control field is set to 1, the sequence number field specifies the sequence number that the sender will use to start numbering its application data. The acknowledgement number field is 32-bit long and includes an ACK bit in the control field. When the ACK bit is set to “1”, the acknowledgement number field specifies the sequence number of the data byte the sender of the segment is expecting. The acknowledgement number acknowledges the receipt from the remote end of all data bytes up to, but not including the data byte with that sequence number. A data offset field is 4-bit long and specifies the length of the segment header measured in 32-bitmultiples. The reserved field is 6-bit long, and the control field is 6-bit long.

The Source IP Address field and Destination Address field contain the source and destination IP addresses used when the TCP segment is sent. A Proto field contains the IP protocol type code, which is 6 for TCP. The TCP Length field contains the length of the TCP segment in bytes. A byte that has only 0's is used to pad the segment to an exact multiple of 16 bits. By including the pseudo-header, the checksum protects against segments that may not be corrupted, but may have been delivered to the wrong destination. The TCP header carries only the protocol port value. To verify the destination, the TCP on the sending host computes a checksum that covers the destination IP address and the TCP segment. At the intended destination, the TCP verifies the checksum using the destination IP address obtained from the header of the IP packet that was carrying the TCP segment. If the checksums match, the segment has successfully reached the intended destination host and the correct protocol port within that host. If the checksums do not match, the segment has reached the wrong destination and must be discarded. The urgent pointer field is 16-bit long and valid only when the URG bit in the control field is set to 1. If valid, the sender would like to send data that it considers urgent. The pointer value in the field identifies the end of the urgent data.

In a three-way handshake, the client computer sends a TCP connect request to the server. In a connect request, the SYN bit in the control field is set to 1. The connect request has a predetermined sequence number. Although the connect request contains no application data, the presence of the sequence number is necessary because the computer must use that same sequence number in case it needs to retransmit this particular connect request. The sequence number in this connect request determines where the TCP begins numbering the data bytes for this connection. The application data starts with a sequence number one higher than the sequence number in the connect request. The ACK bit in the control field is set to 0 so that the acknowledgement number has no significance. The TCP in the server responds back to the computer with a connect response. In the connect response, the SYN bit is set to 1 and the ACK bit is set to 1. Since the ACK bit is set to 1, the acknowledgement number is valid. A recipient may refuse a connection by responding with a Reset. In a Reset, the RST bit in the control field is set to 1.

Packets may get lost, corrupted, delayed, or duplicated during transmission. The design of TCP incorporates several measures to deal with these problems, for example, the three-way handshake is one measure and the choice of an initial sequence number for a new connection is another measure. The TCP selects a number that no longer exists in the network from a previous connection. The TCP specifications recommend basing initial sequence numbers on a clock that increments about every four microseconds. If a system loses the value of the clock, possibly due to a system crash, the system does not send TCP segments for a quiet time of several minutes after it restarts.

Each TCP segment header has an advertise window. A receiver uses the advertise window to inform a sender about available buffer space in the receiver buffer. The sender uses this information to determine whether to send data at a higher data rate. This process is referred to as flow control. For example, if the computer has sent 50 bytes to the server, it is assumed that an advertise window was sent during the three-way handshake procedure. The window is increased if enough space is available to send ¼ of a maximum segment. This avoids very small TCP segments from being generated due to unnecessarily tiny window indications.

When a system has sent all application data, that system sends a TCP close indication with the FIN bit in the control field set to 1. For example, if the computer closes the connection, the computer generates a TCP close indication segment with the FIN bit set. Since no application data is present in the close indication, the sequence number is the value of the last byte of data sent by the computer. The server acknowledges the close indication. The computer may continue to receive data until the workstation that closes the connection requests to do so. At the same time, the server TCP informs its application that the computer has closed half of the connection. The server TCP waits for the application to confirm that it is also finished with the connection. When it receives that confirmation, the server TCP sends to the computer a close indication segment with the FIN bit in the control field set. The computer must acknowledge this close indication.

The TCP offers end-to-end congestion control. However, the TCP cannot directly respond to congestion as it develops in the network because of delay that may be experienced at switches or routers, or both, in the network infrastructure. As these devices have finite storage capacity, packets may be dropped if buffers overflow. The TCP retransmits if ACKs are not returned from the remote TCP. This worsens the problem in the network since more packets are injected into the network causing more packets to be discarded. In one embodiment, the TCP output may be reduced in response to an increasing delay for TCP ACKs to return to the sender. In case of a moderate congestion situation, for example, upon the loss of a segment (e.g., ACK does not return), the congestion window is reduced by ½ to a minimum of one segment and the TCP performs a fast recovery algorithm.

If case of a serious congestion, the sender detects a time out and stops the transmitting. The TCP performs a slow start algorithm probing the traffic situation. The round trip timeout (RTO) and the round trip time estimation (RTT) remain unchanged.

As soon as the congestion stops, the TCP slowly restarts. Under the slow start method, the method starts the congestion window at a single segment and increases the window by one segment per received acknowledgement. When the congestion window reaches 0.5 of its original size, the method enters a congestion avoidance phase. In this phase, the rate of the TCP traffic is increased by one if all segments in the window have been acknowledged.

### TCP in the System of FIG. 1

Generally, the TCP provides a stream-like service for a “higher” application. The application sends a data stream to the TCP, which breaks the data stream into smaller fragments (packets) suitable for delivery to the lower physical layer. Each packet can be routed independently by the IP layer. Thus, the TCP layer provides for sequencing, reliability, flow control and congestion control to maintain the “stream-like” behavior. For example, when an HTML file is sent from the host server 20, the TCP program layer in the host server 20 divides the file into one or more packets, numbers the packets, and then forwards them individually to the IP program layer. Although each packet has the same destination IP address, it may get routed differently through the network. At the other end (the client program), the TCP reassembles the individual packets and waits until they have arrived to forward them as a single file. In the OSI reference model, the TCP is in the transport layer (Layer 4).

From the perspective of the host server 22, the system 1 includes a TCP protocol stack and a WTCP protocol stack. At the terminals 8, 10, the local TCP protocol is modified, whereas and the host server 22, the local TCP protocol is not modified. In one embodiment, the transport layer protocol and the network layer protocol are modified in the WTCP server 16. In another embodiment, the link layer protocol may be modified.

At the WTCP server 16, from the application point of view, the system interface is the original socket interface to provide for downward compatibility. Existing applications can run over the operating system without noticing that WTCP exists underneath. An application can use the message “socket( )” to create a socket and use the messages “connect( )” and “accept( )” to establish the end-to-end connections. After the connection is established, both ends can send traffic by regular “send( )” and “receive( )” messages. In one embodiment, the interface boundary between the transport layer and the link layer is not modified. The kernel is modified, but the modification is not noticeable from the upper layers.

### Fast Retransmit/Fast Recovery

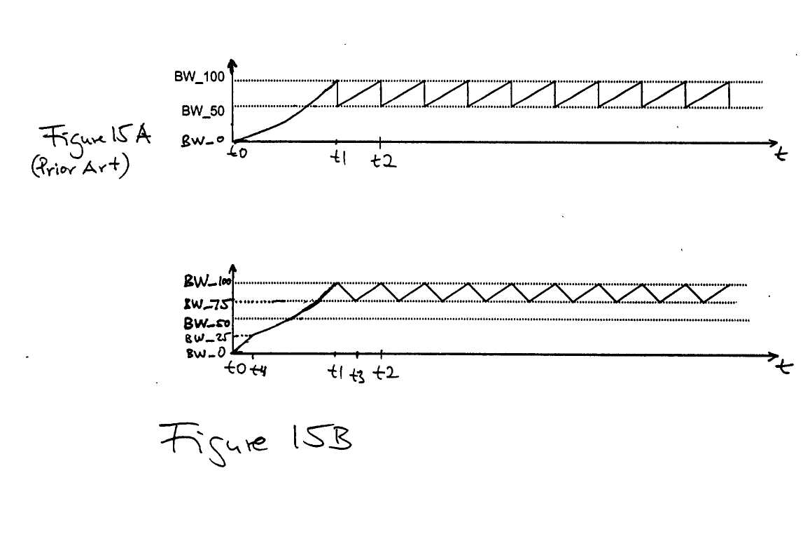

In one embodiment, the system 1 is configured to perform an algorithm for fast retransmit and fast recovery. When a TCP sender receives several duplicate acknowledgements (ACKs), a fast retransmit function allows the sender to infer that a segment was lost. The sender retransmits what it considers to be the lost segment without waiting for the full timeout, thus saving time and improving throughput. After a fast retransmit, a sender invokes a fast recovery function. The fast recovery function allows the sender to transmit at half its previous rate (regulating the growth of its window based on congestion avoidance), rather than having to begin a slow start, so that the throughput is higher. The slow start method is further described below with respect to FIGS. 15A, 15B.

According to one embodiment of the algorithm for fast retransmit and fast recovery implemented in the system 1, when a third duplicate ACK is received, the algorithm sets in a first step the threshold value ssthresh to no more than the value given by: ssthresh=max (cwnd/2, 2*MSS), where cwnd is the size of the congestion window and MSS is the maximum segment size. The algorithm retransmits in a second step the lost segment and sets the congestion window to: cwnd=ssthresh+3*MSS. This artificially “inflates” the congestion window by the number of segments (e.g., 3) that have left the network and which the receiver has buffered.

For each additional duplicate ACK received, the algorithm increments in a third step the congestion window cwnd by the number of segments MSS. This artificially inflated congestion window reflects the additional segment that has left the network. The algorithm transmits in a fourth step a segment if allowed by the new value of the congestion window cwnd and the receiver's advertised window size. When the next ACK arrives that acknowledges new data, the algorithm sets in a fifth step the size of the congestion window cwnd to the initial threshold value ssthresh, thereby “deflating” the window. This ACK should be the acknowledgment elicited by the retransmission from the first step, one round trip time (RTT) after the retransmission, although it may arrive sooner in the presence of significant out-of-order delivery of data segments at the receiver. Additionally, this ACK should acknowledge all the intermediate segments sent between the lost segment and the receipt of the third duplicate ACK, if none of these were lost.

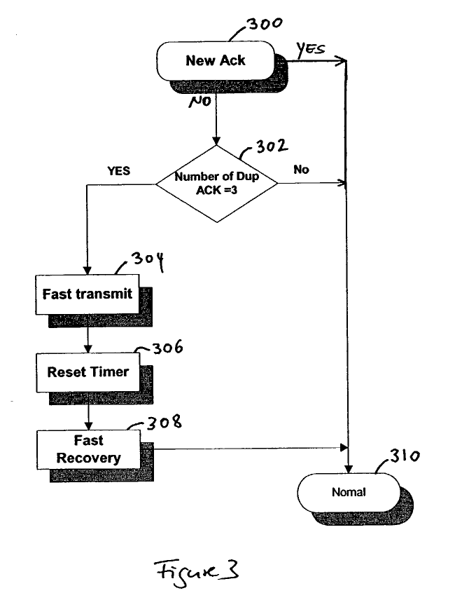

FIG. 3 illustrates one embodiment of the algorithm for fast retransmit and fast recovery that starts at a step 300. If a new acknowledgement is received, i.e., not a duplicate acknowledgement, the algorithm proceeds along the YES branch to a step 310 indicating the acknowledgement is a “normal” acknowledgment. If the acknowledgement is a duplicate, i.e., not “new,” the algorithm proceeds along the NO branch to a step 302. Since the TCP does not know whether a duplicate ACK is caused by a lost segment or just by a reordering of segments, the TCP waits for a small number of duplicate ACKs to be received, as illustrated in the step 302. If a reordering of the segments occurred, there are only one or two duplicate ACKs before the reordered segment is processed, i.e., the algorithm proceeds along the NO branch to the step 310, which will then generate a new ACK. If three or more duplicate ACKs are received in a row, it is a strong indication that a segment has been lost. When the third duplicate ACK is received, the threshold value ssthresh is set to one-half of the current congestion window, cwnd, but no less than two segments.

The algorithm then proceeds along the YES branch to a step 304 in which the TCP performs a retransmission of what appears to be the missing segment, without waiting for a retransmission timer to expire. After the fast retransmit step sends what appears to be the missing segment, congestion avoidance is performed in one embodiment instead of a slow start. It is an improvement that allows high throughput under moderate congestion, especially for large windows. In this embodiment, the fast retransmit is preferred over the slow start because the receipt of the duplicate ACKs tells the TCP more than just that a packet has been lost. Since the receiver can only generate the duplicate ACK when another segment is received, that segment has left the network and is in the receiver's buffer. That is, there is still data flowing between the two ends of the connection, and the TCP does not reduce the flow abruptly by going into a slow start mode.

In a step 306, the algorithm restarts a retransmit timer. Since it is assumed that the network condition is still acceptable, the TCP reacts by a fast recovery mechanism as illustrated in a step 308. After the fast retransmit in the step 304, the TCP keeps track of the number of ACKs received between the retransmitted packet and the highest sequence number that has been sent to the network. The packets in the current window are subject to the same transient behavior of the network and should be fixed as soon as possible, using the congestion window size similar to the previous round trip. The congestion window cwnd is set to ssthresh+3 times the segment size. When another duplicate ACK arrives, the congestion window cwnd is increased by the segment size. A packet is then transmitted. By increasing the congestion window for each ACK received, the window can receive more outstanding packets to recover any losses. Furthermore, during that window of loss, the congestion window shrinks only once. When all packets belonging to the original congestion window have been fixed, an arriving new ACK triggers the reset of the congestion window cwnd to ssthresh+3 times the segment size.

### Increase Initial Window

The system 1 may further be configured to perform an algorithm that increases the initial window. A traditional slow start method (for example, shown in FIG. 15A), with an initial window of one segment, is a time-consuming bandwidth adaptation procedure over wireless networks. An increased initial window does not contribute significantly to packet drop rates, but it has the added benefit of improving initial response times when the peer device delays acknowledgements during slow start. For example, an initial window of 2 allows clients running query-response applications to get an initial ACK from unmodified servers without waiting for a typical delayed ACK timeout of 200 milliseconds. Thus, the increased initial window provides for a saving of two round-trips.

More particularly, when the TCP starts the connection, the TCP starts using a slow start procedure to probe the bandwidth of the channel. The slow start procedure is used when a connection just started and the TCP has no knowledge of the network's current traffic or bandwidth condition. The slow start procedure is also used when a timeout occurred because the channel is congested. Again, as there is not sufficient information as to how much bandwidth the channel has, the TCP uses the slow start procedure. The TCP, thus, starts to probe the network starting from a congestion window of 1 and exponentially probing the bandwidth of the channel. Once a bandwidth “ceiling” is detected, the TCP enters into a congestion avoidance mode. In one embodiment, the TCP may suppress acknowledgments (“ACK suppression”) to reduce waste of bandwidth.

In another embodiment, the initial size of the congestion window may be 2 for two segments. This allows clients running query-response applications to get at least an initial ACK from unmodified servers without waiting for a typical delayed ACK timeout of 200 milliseconds, and saves two round-trips. It is contemplated that in other embodiments, the initial window may be larger than 2.

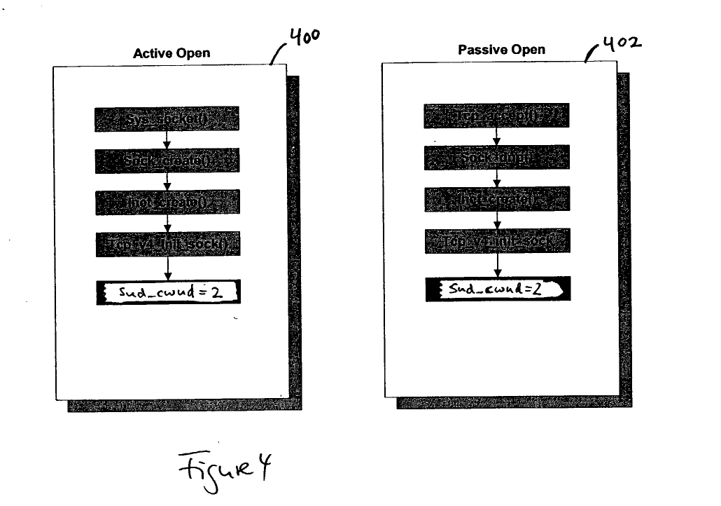

FIG. 4 illustrates one embodiment of the algorithm that increases the initial window. The illustration includes an active open block 400 and a passive open block 402. The active open block 400 represents the end point that sends the first SYN packet initializing that particular connection. The host server 20 is performing what is referred to as “active open.” The active open block 400 illustrates the messages Sys_socket( ), which initializes the socket, Socket_create( ), which creates the socket, Inet_create( ), which creates the socket in the INET layer, Tcp_v4_init_sock( ), which initializes the socket in the TCP layer, and Snd_cwnd, which sets the initial congestion window.

The passive open block 402 represents the end point that receives the first SYN packet from the other side and listens for the new connection request. This end point returns the SYN+ACK packet in response to the request. The end point performs what is referred to as “passive open.” The passive open block 402 illustrates the messages TCP_accept( ), which accepts the open socket request from other side, i.e., the active open block 400), Sock_dup( ), which duplicates the socket, Inet_create( ), which creates the socket in the INET layer, Tcp_v4_init_sock( ), which initializes the socket in the TCP layer, and Snd_cwnd, which sets the initial congestion window.

Congestion can occur when data arrives, for example, over a “fast” LAN and is sent out, for example, over a “slower” WAN, or when multiple input streams arrive at a router whose output capacity is less than the sum of the inputs. Network congestion downgrades the performance of transaction due to lost packets. The conventional TCP would start a connection with the sender injecting multiple segments into the network, up to the window size advertised by the receiver. While this is acceptable when the hosts are connected to the same LAN, but if routers and slower links exist between the sender and the receiver, problems may arise. For example, an intermediate router must queue the packets, and it is possible for that router to run out of space.

The slow start procedure may reduce these problems. The slow start procedure operates by observing that the rate at which new packets should be injected into the network is the rate at which the acknowledgments are returned by the other end. The slow start procedure adds another window to the sender's TCP: the congestion window “cwnd.” When a new connection is established with a host on another network, the congestion window is initialized to one segment. Each time an ACK is received, the congestion window is increased by one segment. However, the slow-start algorithm is intended to be slow because it always starts with a congestion window of one, i.e., cwnd=1. In certain embodiments of the system 1, the congestion window may be set to 2, 3 or 4 to achieve a quick start as well as to avoid congestion in the network. In one embodiment, the congestion window is set to 2. The slow-start algorithm is further described below with respect to FIGS. 15A and 15B.

### Explicit Congestion Notification

Further, the system 1 may be configured to perform an algorithm that provides for explicit congestion notification. With an explicit notification from the network it is possible to determine when a loss is due to congestion. Of various proposals, explicit congestion notification (ECN) provides benefits for TCP connections on wireless networks, as well as for other TCP connections. Also, ECN is useful to avoid further deteriorating of a critical network situation.

More particularly, in one embodiment, two bits are specified in the IP header, the “ECN-Capable Transport” (ECT) bit and the “Congestion Experienced” (CE) bit. If the ECT bit is set to “0”, the ECT bit indicates that the transport protocol will ignore the CE bit. This is the default value for the ECT bit. If the ECT bit is set to “1”, the ECT bit indicates that the transport protocol is willing and able to participate in ECN. The default value for the CE bit is “0” indicating a transmission free of congestion. The router sets the CE bit to “1” to indicate congestion to the end nodes, but does not reset the CE bit in a packet header from

The TCP, as implemented in one embodiment of the system 1, defines a negotiation phase during a setup stage to determine if both end nodes are ECN-capable, and two new flags in the TCP header using the “reserved” flags in the TCP flags field. The ECN-Echo flag is used by the data receiver to inform the data sender of a received CE packet. A “Congestion Window Reduced Flag” is used by the data sender to inform the data receiver that the congestion window has been reduced.

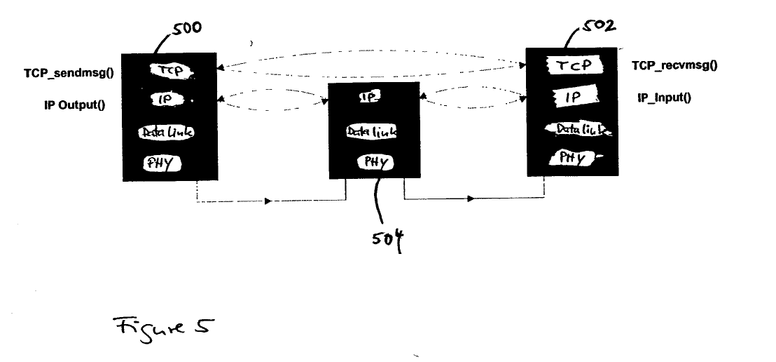

FIG. 5 is an exemplary illustration of the explicit congestion notification implemented in one embodiment of the system 1. The messages TCP_sendmsg( ) and TCP_recvmsg( ) are a pair of the functions that perform the TCP-level ECN. It will be executed between two TCP endpoints 500, 502. The messages IP_output( ) and IP_input( ) are a pair of the functions that perform the IP ECN, which operates on a per-hop basis between the endpoints 500, 502 via an intermediate point 504.

### Header Compression

In a further embodiment, the system 1 may be configured to perform an algorithm that performs a compression of the headers. Because wireless networks are bandwidth-constrained, compressing every byte out of over-the-air segments may be beneficial. Mechanisms for TCP and IP header compression provide for improved interactive response time, allow using small packets for bulk data with good line efficiency, allow using small packets for delay sensitive low data-rate traffic, decrease the header overhead to less than 1% (for example, for a common TCP segment size of 512 the header, the overhead of IPv4/TCP header within a Mobile IP tunnel can be as high as 11.7%), and reduce the packet loss rate over lossy links, among others, because of the smaller cross-section of compressed packets.

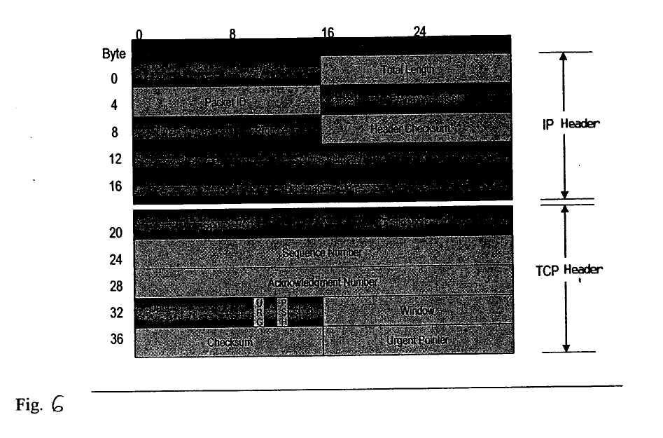

A typical packet format includes information that is likely to stay constant over the life of a connection. In a compressed TCP/IP packet format shown in FIG. 6, a change mask identifies which of the fields expected to change per-packet actually have changed. The compressed TCP/IP format includes a connection number so that the receiver can locate a saved copy of the last packet for this TCP connection and the unmodified TCP checksum so the end-to-end data integrity check will still be valid. Each bit set in the change mask, the amount the associated field changed.

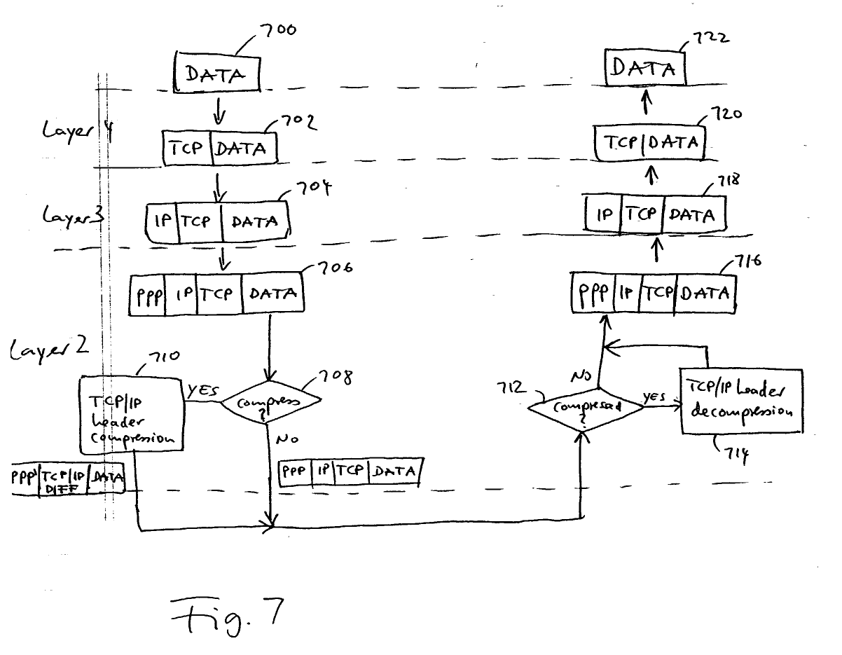

FIG. 7 is a further illustration of the header compression algorithm, represented as a steps 700-722, that performs TCP and IP header compression on the transmit side and TCP/IP header decompression on the receive side. In a block 700, the application submits data to the layer 4, which adds a TCP header to the data, as shown in a step 702. In a step 704, the algorithm adds in layer 3 an IP header, and in a step 706, the algorithm adds in layer 2 a point-to-point (PPP) header. In a step 708, the algorithm determines if it is possible to compress the TCP/IP header. If it is not, the algorithm proceeds along the NO branch to a step 712, i.e., the packet remains untouched. If it is possible to compress the TCP/IP header, the algorithm proceeds along the YES branch to a step 710. In the step 710, the algorithm compresses the TCP/IP header by calculating the difference between the current TCP/IP header and the previous TCP/IP header. Thus, the packet includes only the differences (TCP/IP Diff) instead of the complete TCP/IP header. To indicate that the TCP/IP header is compressed, the PPP header is flagged (PPP′).

On the receive side, the algorithm determines if the TCP/IP header is compressed, as indicated in a step 712, by determining if the PPP header is flagged. If the TCP/IP header is compressed, the algorithm proceeds along the YES branch to a step 714 for TCP/IP header decompression. The algorithm processes the difference (TCP/IP diff) with respect to the previous TCP/IP header. If the TCP/IP header is not compressed, the algorithm proceeds along the NO branch to step 716. In steps 716-722, the algorithm removes the headers in reverse order to the steps 700-706.

### Delayed Duplicate Acknowledgement

In addition, the system 1 may be configured to perform an algorithm that provides for delayed duplicate acknowledgements. The link-layer retransmissions may decrease the bit error rate enough so that congestion accounts for most of the packet losses. In a wireless environment, interruptions occur because of handoffs from one cell to another and because mobile terminals move beyond wireless coverage. In such an environment, interactions between the link-layer retransmission and the TCP retransmission are to be avoided as these layers duplicate each other's efforts. The delayed duplicate acknowledgement scheme selectively delays duplicate acknowledgements at the receiver. It may be preferable to allow a local mechanism to resolve a local problem, instead of invoking the TCP's end-to-end mechanism and incurring the associated costs, both in terms of wasted bandwidth and in terms of its effect on TCP's window behavior. The scheme of delayed duplicate acknowledgements can be used despite of IP encryption, or other mechanisms, because the intermediate node does not need to examine the TCP headers.

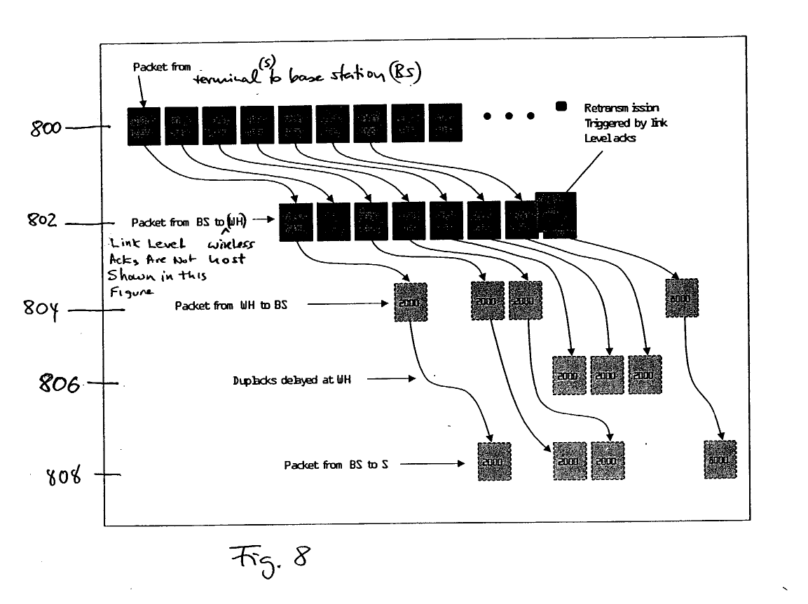

In the scheme of delayed duplicate acknowledgments, the base station does not need to look at the TCP headers. FIG. 8 is an illustration of one embodiment of the delayed duplicate acknowledgements scheme. FIG. 8 shows boxes containing two sequence numbers that denote TCP data packets, and boxes containing a single sequence number that denote the TCP acknowledgements. For instance, in a line 800, the box containing 2000:2999 denotes a TCP packet that contains the 1000 bytes with sequence numbers 2000 through 2999. A TCP acknowledgement that contains a sequence number, e.g., 2000, denotes that the receiver has received all bytes through 1999, but not the byte 2000. In a line 802, a diagonal line through the data packet 2000:2999 sent by the base station (BS) denotes that the packet is lost due to transmission errors and has not been received by the wireless host (WH). In lines 800-808, the packets are interconnected through arrows. An arrow from a packet X to a packet Y denotes that the packet X is the cause for the packet Y. As illustrated in lines 800 and 802, the base station retransmits the packet 2000:2999 when the link layer acknowledgement requests retransmission, i.e., on receipt of the first duplicate acknowledgement. The retransmission of the packet 2000:2999 is shown on the right hand side of line 802. As shown in line 804, middle, the base station sends two duplicate acknowledgements and an acknowledgement for the highest packet 7000:7999. Also, the base station delays the duplicate acknowledgements with the sequence number 2000, as shown in line 806. The TCP sender does not receive any of these duplicate acknowledgements, and remains unaware of the transmission error.

The base station implements a link level retransmission scheme for packets that are lost on the wireless link due to transmission errors. In one embodiment of the system 1, the delayed duplicate acknowledgment scheme is implemented without making the base station TCP-aware.

In the delayed duplicate acknowledgment scheme, the TCP receiver attempts to reduce interference between the TCP and link-level retransmissions by delaying third and subsequent duplicate acknowledgements for an interval “d”. Specifically, when out-of-order (OoO) packets are received, the TCP receiver responds to the first two consecutive OoO packets by sending duplicate acknowledgements immediately. However, duplicate acknowledgements for further consecutive OoO packets are delayed for the duration d. If the next in-sequence packet is received within the interval d, the delayed duplicate acknowledgements are not sent. Otherwise, after the interval d, all delayed duplicate acknowledgements are released.

In one embodiment of the system 1, the link layer gives higher priority to link layer acknowledgements, as compared to link layer data. Similarly, retransmitted link layer data packets are given a higher priority compared to other link layer data packets. This priority mechanism is used to speed up detection and recovery of packet losses due to transmission errors.

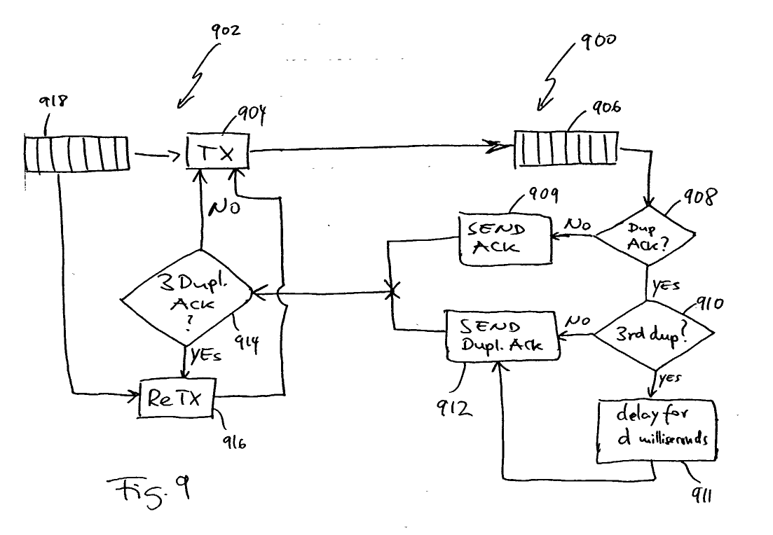

FIG. 9 is another illustration of one embodiment of the delayed duplicate acknowledgement scheme between a sender 902 and a receiver 900. In a step 904, the sender 902 sends a TCP level packet. In a step 906, the receiver 900 receives a packet in a buffer and determines if this packet is a duplicate acknowledgement, as indicated in a step 908. If the packet is not a duplicate acknowledgement, i.e., a “normal” packet, the algorithm proceeds along the NO branch to a step 909 and sends an acknowledgement. If the packet is a duplicate acknowledgement, the algorithm proceeds along the YES branch to a step 910 in which the algorithm determines if three duplicate acknowledgements have been received. If the packet is the third duplicate acknowledgment, the receiver 900 delays the acknowledgement for a predetermined time d and then sends a duplicate acknowledgement to the sender 902, as indicated in steps 911 and 912. In certain embodiments, the time d may be between about 200 and about 500 milliseconds. In one embodiment, the time d is about 200 milliseconds. If the packet is not the third duplicate acknowledgement, the algorithm proceeds along the NO branch to the step 912 and sends a duplicate acknowledgement to the sender 902, as indicated in the step 912.

In a step 914, the sender 902 determines if the incoming data packet deviates from the sequence number of the previously received packet for the third time. If it is the third duplicate acknowledgement, the algorithm proceeds along the YES branch to a step 916 and the sender 902 retransmits the packet that is in front of the send queue in the sender buffer 918. If the received packet is not the third duplicate acknowledgement, the algorithm proceeds along the NO branch to the step 904 and the next packet is transmitted.

### TCP Control Block Interdependence

The system 1 may be configured to perform an algorithm that provides for TCP control block interdependence. The TCP maintains per-connection information such as connection state, current round-trip time, congestion control or maximum segment size. To improve performance of a new connection, the TCP shares information between two consecutive connections or when creating a new connection while the first is still active to the same host. Users of wireless WAN devices frequently request connections to the same servers or set of servers. For example, in order to read emails or to initiate connections to other servers, the devices may be configured to always use the same email server or WWW proxy. In one embodiment, the TCP control block algorithm relieves the application of the burden of optimizing the transport layer. In order to improve the performance of TCP connections, this algorithm only requires changes at the wireless device. In general, this scheme improves the dynamism of connection setup without increasing the cost of the implementation.

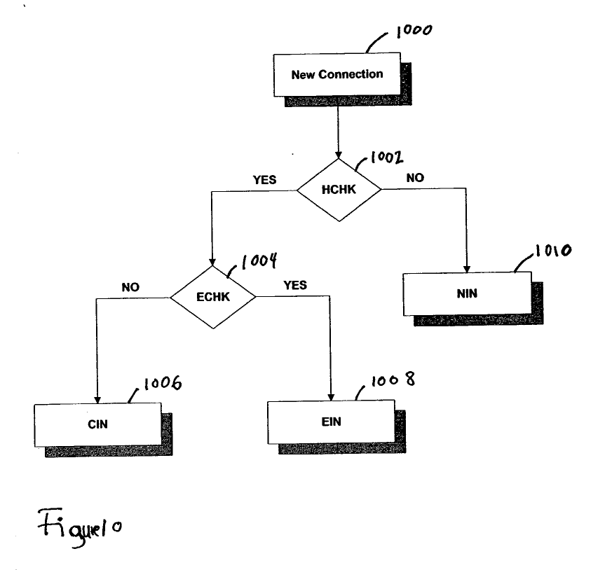

FIG. 10 is an illustration of one embodiment of the TCP control block interdependence implemented in one embodiment of the system 1 for use in a new connection. When a user causes an application to call tcp_connect( ), the three way handshake begins. After the three way handshake, most of the connection states are reset to zero by the kernel. If a cache entry of the connection state is kept for the connections that have been closed, some of the “old” states can be used for a new connection, which is represented in a step 1000. For example, the “old” states Maximum Segment Size, RTT, RTT variance, ssthresh, and the congestion window may be used for the new connection.

As indicated in a step 1002, the algorithm checks if this host was previously connected (“HCHK”). If the host was not previously connected, the algorithm proceeds along the NO branch to a step 1010, in which the algorithm initializes the TCP normally (“NIN”). However, if the host was previously connected, the algorithm proceeds along the YES branch to a step 1004.

In the step 1004, the algorithm checks if the previously connected host is still connected (“ECHK”). If the host is still connected, the algorithm proceeds along the YES branch to a step 1008, in which the algorithm initializes the TCP using parameters of the existing, concurrent connection (“EIN”). If the host is not connected anymore, the algorithm proceeds along the NO branch to a step 1006, in which the algorithm initializes the TCP from parameters of an earlier, but now closed connection (“CIN”).

### Active Queue Management

Furthermore, the system 1 may be configured to perform an algorithm that provides for active queue management. The TCP responds to congestion by closing down the window and invoking the slow start procedure. Long-delay networks such as wireless networks take a particularly long time to recover from a congestion situation. The active queue management may prevent “congestion collapse” by controlling the average queue length at the routers. Advantageously, the algorithm may reduce packet drops in network routers. By dropping a few packets before severe congestion sets in, a random early detection (RED) feature avoids dropping bursts of packets. That is, the objective is to drop m packets early to prevent n drops later on, where m is less than n. Further, the active queue management provides for lower delays because of smaller queue lengths. This may be important for interactive applications in which the inherent delays of wireless links negatively affect the user experience. Furthermore, lock-outs are avoided because of a lack of resources in a router, and any resulting packet drops, may obliterate throughput on certain connections. Because of active queue management, it is more probable for an incoming packet to find available buffer space at the router.

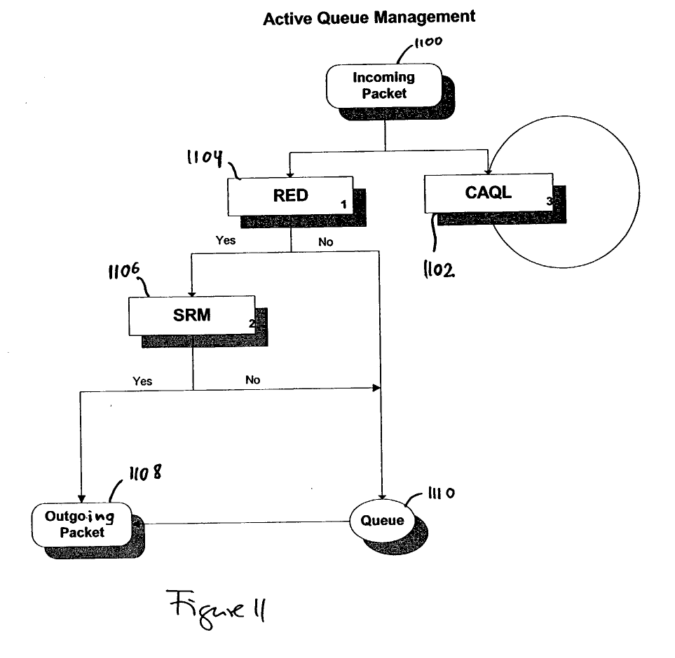

FIG. 11 is an illustration of an algorithm that provides for active queue management implemented in one embodiment of the system 1. In a step 1100, a packet is incoming that may be subject to a detection of non-conforming traffic in a step 1104 (RED), and to a calculation of an average queue length (AQL) in a step 1102 (CAQL) for use by the RED feature. Hence, the implementation of the algorithm is based on an estimation of the average queue length and a decision of whether or not to drop an incoming packet. In one embodiment, the RED feature estimates the average queue length, either in a forwarding path using an exponentially weighted moving average, or in the background using also an exponentially weighted moving average. The queue length may be measured in units of packets or of bytes. When the average queue length is computed in the forwarding path, a situation may exist in which a packet arrives and the queue is empty.

The RED feature decides whether or not to drop an incoming packet. The RED feature may have two parameters, a minimum threshold value “minth” and a maximum threshold value “maxth”, both of which are preferably set at values below the maximum buffer size, such that minth<maxth<max_buffer_size. The decision whether or not to drop an incoming packet can be made in a “packet mode”, which ignores the packet sizes, or in “byte mode”, which takes into account the size of the incoming packet. In packet mode, the queue length is expressed as a number of packets, whereas in byte mode, the queue length is expressed as a number of bytes. When a new packet arrives, it is queued if the AQL is less than minth, and dropped if the AQL is greater than maxth. If the AQL falls in the range values from minth to maxth, an algorithm is used to calculate a loss probability between the values of 0 and 1. In one embodiment this algorithm returns a loss probability that is directly proportionate to the AQL, such that the relation between the AQL and the loss probability is perfectly linear (loss probability=f(AQL)=k·AQL). By setting maxth at a value below the maximum buffer size, the algorithm takes the available buffer space into account.

When the queue length is higher than a threshold, the algorithm drops the packet. If the sender does not react to the drop or the round trip time (RTT) is so long such that the sender has not received the congestion notification message, the queue length may increase further. The longer the queue is, the higher the probability of dropping a packet. If all queue spaces in a router are already used or if the link flow control prohibits the packet from queuing in the link interface, the router buffers drops the packet. By using the RED feature, the average queue length can be kept low, lowering the latency.

If non-conforming traffic is detected in the step 1104, the algorithm proceeds to a step 1106. If the traffic is conforming, the algorithm proceeds to a step 1110 and the packet is added to the queue. In the step 1106, the algorithm performs a system resource monitoring (SRM) to avoid inundating the router with excessive packets. If the system resources are sufficient, the algorithm forwards the outgoing packet, as indicated in a step 1108. If the system resources are insufficient, the algorithm adds the packet to the queue, as indicated in the step 1110. From the queue, the packets are transferred to outgoing packets.

### Selective Acknowledgement

In one embodiment, the system 1 may be configured to perform an algorithm that provides for selective acknowledgement (SACK). The TCP may experience poor performance when multiple packets are lost from one window of data. With the limited information available from cumulative acknowledgments, a TCP sender detects one lost packet per round trip time. An aggressive sender could choose to retransmit packets early, but such retransmitted segments may have already been successfully received. The selective acknowledgment mechanism (SACK mechanism) helps to overcome these limitations. The receiving TCP sends SACK packets back to the sender informing the sender of data that has been received. The sender can then retransmit only the missing data segments.

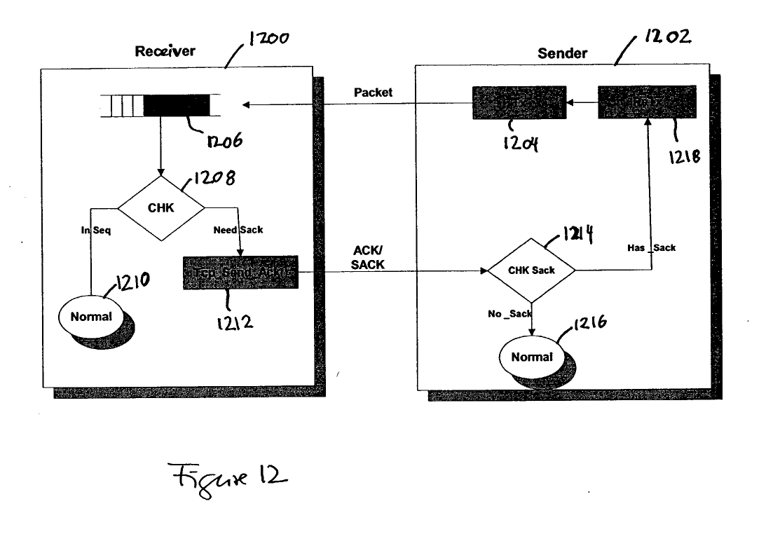

FIG. 12 is an illustration of the algorithm that provides for selective acknowledgement in one embodiment of the system 1 between a sender 1202 and a receiver 1200. In a step 1204, the sender 1202 sends a packet to the receiver 1200. In a step 1206, the receiver 1200 places the packet in a receive queue. In a step 1208, the algorithm checks the receive queue for potential out of sequence packets. If none is detected, the algorithm proceeds to a step 1210, which is indicated as “Normal.” If the algorithms detects an out of sequence packet, the algorithm proceeds to a step 1212. In the step 1212, the algorithm generates an SACK block within the ACK package for sending to the sender 1202, as indicated as “Tcp_Send_Ack( )”. Further, in a step 1214, the algorithm checks if the SACK block is available in the received ACK package. If the SACK block is available, the algorithm proceeds to a step 1218, in which the packet that is in front of the send queue is retransmitted. If no SACK block is available, the algorithm proceeds to a step 1216 “Normal.”

### Snoop Protocol

In one embodiment, the system 1 may implement the “Berkeley Snoop protocol” of the Daedalus Research Group, University of California Berkeley, a description of which is available at http:H/nms.lcs.mit.edu/˜hari/papers/snoon.html. The Snoop protocol is a link layer protocol that is aware of the transport layer (TCP). It was designed to improve the performance of TCP over networks having both wired and single-hop wireless links. As described by the Daedalus Research Group, the Snoop protocol works by deploying a Snoop agent at a base station of a wireless LAN and performing retransmissions of lost segments based on duplicate TCP acknowledgments, which are a strong indicator of lost packets, and locally estimated last-hop round-trip times. The Snoop protocol locally retransmits on the wireless link lost packets, instead of allowing TCP to do so end-to-end. Further, the agent suppresses duplicate acknowledgments corresponding to wireless losses from the TCP sender, thereby preventing unnecessary congestion control invocations at the sender. The Snoop protocol is designed to avoid unnecessary fast retransmits by the TCP sender, when the wireless link layer retransmits a packet locally. The Snoop protocol deals with this problem by dropping TCP duplicate acknowledgements appropriately at the intermediate node.

In another embodiment the system 1 may implement an I-TCP protocol. One such implementation is described in “I-TCP: Indirect TCP for Mobile Hosts” by Ajay Bakre and B. R. Badrinath in the 15^{th} International Conference on Distributed Computing Systems (May 1995). I-TCP adds a mobile support router (MSR) to the TCP layer, transparently splitting the TCP connection between the mobile host (MH) and the corresponding host (CH) into two connections: a connection between the mobile host and the mobile support router (MH-MSR) and a connection between the mobile support router and the corresponding host (MSR-CH). This split separates the wireless MH-MSR connection from the wired MSR-CH connection, allowing the wireless connection to be optimized independently of the wired connection. A benefit if this is the minimization of transient loss. As a wireless handoff occurs, the MH-MSR connection is transferred from one MSR to another. In terms of software architecture, I-TCP is generally implemented as a user-level process.

In yet another embodiment the system 1 implements an IST-TCP protocol. In this implementation, the wireless connection is separated from the wired one at the socket layer. This is advantageous as more connection parameters, such as bandwidth and latency, are generally known at the socket layer than at the transport (TCP) layer. The availability of these parameters allows better optimization of the connection. Preferably the IST-TCP protocol is implemented as a kernel level process, with a dynamic link library serving as an interface. This avoids the need to change any program at the application layer. In one specific embodiment an amount of kernel memory is pre-assigned and locked for the exclusive use of the IST-TCP protocol. This reduces the amount of information that is transferred between kernel memory and application memory.

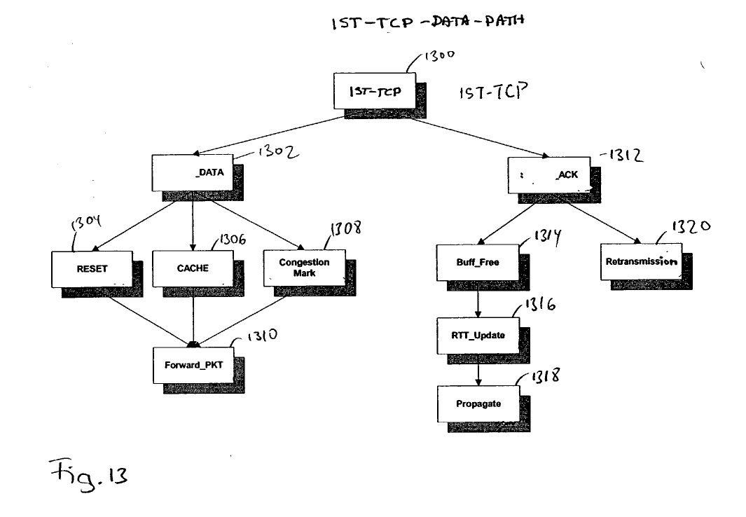

FIG. 13 is an illustration of the IST-TCP protocol implemented in one embodiment of the system 1 using functional blocks 1300-1318. In a branch represented by blocks 1302-1310, the protocol performs a Data procedure processing and caching packets intended for the mobile host. A local retransmit counter is reset when a new packet in the normal TCP sequence and the packet is added to the cache and forwarded on to the mobile host with a timestamp applied to this packet. An out-of-sequence packet that has been cached earlier if forwarded if the sequence number is greater than the last acknowledgment. Otherwise, a TCP ACK corresponding to the last acknowledgement at the base station is generated and sent to the fixed host. An out-of-sequence packet that has not been cached earlier is forwarded to the mobile host and also marked as having been retransmitted by the sender.

In a branch represented by blocks 1312-1318, the protocol performs an Ack procedure monitoring and processing acknowledgments coming from the mobile host and driving local retransmissions from the base station to the mobile host. The acknowledgement may be a new acknowledgement. By receiving this acknowledgement, the IST-TCP protocol empties the cache and frees the buffer from all acknowledged packets. The IST-TCP protocol also updates estimated round-trip time in each window of transmission and acknowledgement forwarded to the fixed host. A spurious acknowledgement is discarded. A duplicate acknowledgement is either not in the cache or has been marked as having been retransmitted by the sender. If the packet is not in the cache, it invokes the necessary congestion control mechanisms at the sender and asks the fixed host to retransmit the packet. If the packet was marked as a sender-retransmitted packet, the duplicate acknowledgement is routed to the fixed host. If a duplicate acknowledgement is not expected for the packet, the arrival of each successive packet in the window causes a duplicate acknowledgement to be generated for the lost packet. The lost packet is retransmitted as soon as the loss is detected at a higher priority than normal packets. If a duplicate acknowledgement is expected, the acknowledgement is discarded.

### Class-based Queuing

In a further embodiment, the system 1 may be configured to perform an algorithm that provides for a class-based queuing (CBQ). The active queue management helps to control the length of the data queues. Additionally, in certain embodiments, a FIFO algorithm is replaced with other scheduling algorithms that improve fairness, by policing how different packet streams utilize the available bandwidth and router buffer space, thereby improving the transmitter's radio channel utilization. For example, fairness is necessary for interactive applications (like telnet or web browsing) to coexist with bulk transfer sessions.

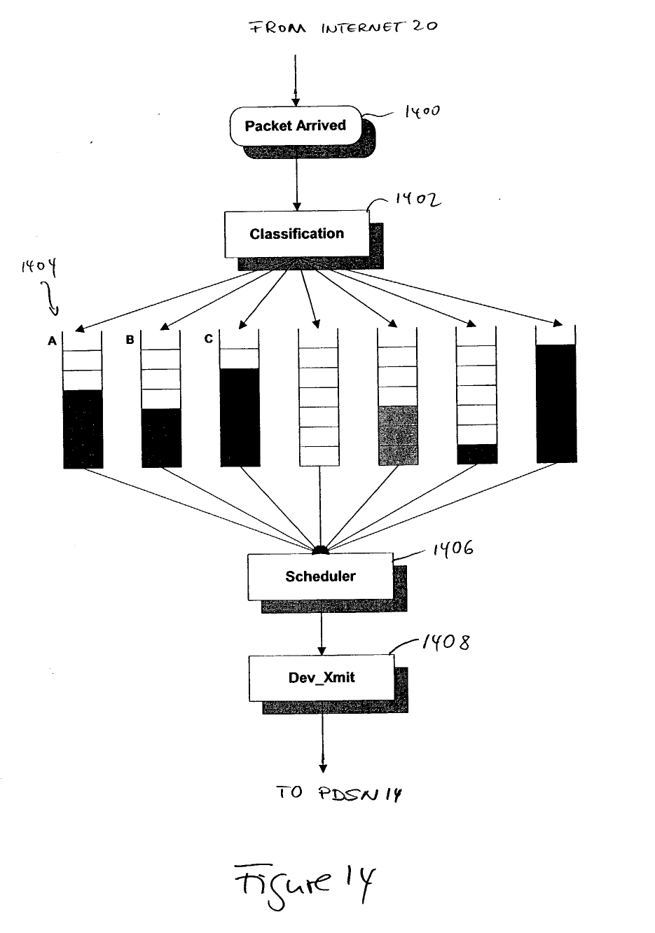

The class-based queuing manages the packet streams based on predefined classes so that new connections for interactive applications do not experience difficulties in starting when a bulk TCP transfer has already stabilized using all available bandwidth. FIG. 14 is a schematic illustration of a class-based queuing in accordance with one embodiment of the system of FIG. 1. When a packet arrives from the Internet 20, as indicated by a block 1400, the algorithm divides the packet into different classes, as indicated by a block 1402. In one embodiment, each class represents data for a single terminal. For example, as indicated by a block 1404, the algorithm generates seven queues for seven classes (A, B, C, . . . ), i.e., seven terminals. Those of ordinary skill in the art will appreciate that FIG. 14 shows seven classes for illustrative purposes. Accordingly, it is contemplated that the algorithm may classify the incoming packet in more or less than seven classes.

The queues of the various classes are forwarded to a scheduling function, as indicated through a block 1406. The algorithm schedules the class packets for transmission and changes the priorities of the classes. For example, the scheduling function sends the packets of the class with the highest priority first and controls in which sequence the packets of the remaining classes are sent. Further, the algorithm forwards the packet to a hardware device for transmission to the PDSN 14, as indicated by a block 1408.

The CBQ operation is based on an interaction between a general scheduler and a link sharing scheduler. The general scheduler guarantees the appropriate service to each leaf class, distributing the bandwidth according to their allocations. The link sharing scheduler distributes the excess bandwidth according to the link sharing structure.

FIGS. 15A and 15B show exemplary graphs illustrating a bandwidth (BW) of a connection as a function of time (t). FIG. 15A illustrates the graph of a conventional slow start and congestion avoidance procedures and FIG. 15B illustrates the graph of a modified procedure as implemented in one embodiment of the system 1. At the beginning of a new connection, the TCP performs the slow start procedure and the TCP uses more and more bandwidth. As illustrated in FIG. 15A, the used bandwidth increases from zero (BW_0) at a time t0 to 100% (BW_100) at a time t1. That is, at time t1, the bandwidth capacity is exhausted and the TCP cannot further increase the traffic.

The procedure then enters into a congestion avoidance mode. As soon as the used bandwidth is 100%, the conventional TCP reduces the traffic by about 50% so that the used bandwidth drops to about 50% (BW-50) at time t1, as shown in FIG. 15A. Thereafter, the TCP probes the connection and increases again the used bandwidth. As shown in FIG. 15A, the bandwidth increases linearly between time t1 and t2. The process of decreasing and increasing the bandwidth between 50% and 100% continues as long as the connection is active.

FIG. 15B shows a modified TCP slow start procedure that robes the connection more aggressively between the start at T0 and a time t4. In one embodiment, the modified procedure is twice as aggressive as the conventional procedure before the used bandwidth is about 25%, as shown in FIG. 15A. Further, the initial congestion window is in one embodiment set to four. During the period between time t4 and t1, the modified TCP procedure is similar to the procedure shown in FIG. 15B. In cellular network, the maximal bandwidth and the characteristics of the network between the WTCP server 16 and the wireless terminals 8, 10 are known. The initial bandwidth therefore could be set to 100% in one embodiment of the system 1. However, the embodiment of the modified TCP procedure shown in FIG. 15B provides for a sufficiently aggressive slow start to improve the overall performance of the system 1.

At time t1, the modified TCP procedure enters in a modified congestion avoidance mode that does not include suddenly drops of the used bandwidth from 100% to 50%. Instead, in the embodiment of FIG. 15B, the modified TCP procedure gradually decreases the used bandwidth from about 100% at time t1 to about 75% at a time t3. As soon as the bandwidth is down at about 75%, the modified TCP procedure increases the used bandwidth until the bandwidth is again about 100%. For illustrative purposes, the bandwidth decrease between t1 and t3, and the bandwidth increase between t3 and t2 occur in a linear manner. The process of decreasing and increasing the bandwidth between about 75% and about 100% continues as long as the connection is active.

When air loss occurs, the procedure may reduce the traffic and the bandwidth at a rate that is less when congestion loss occurs. However, the system 1 has no explicit indication as to which loss is air loss. Without limitation, it is believed that air loss mostly occurs in a burst-like mode. Hence, the system 1 is configured to detect a timeout if long and burst-like losses occur. If a timeout occurs, the round trip timeout (RTO) is reduced and the transmission rate is reduced by one half. If a timeout happens in a burst-like mode, the RTO is reduced to one in 4-5 round trip time.

When the system 1 detects three duplicate acknowledgments, the congestion window is reduced in a linear mode at a rate that is similar to the increase of the congestion window. That is, every time three acknowledgments are detected, instead of always reducing the rate by one half, the system 1 reduces the rate at a rate that is opposite to the rate of the increase. Since the bandwidth increase becomes less aggressive after a used bandwidth of 75%, the system 1 is less likely to reach a highly congested situation.

### System Elements

In one embodiment of the system 1, the WTCP server 16 includes a commercially, from Intel Corporation available IA-32 architecture as a hardware platform and includes a GNU/Linux operating system. Those skilled in the art will appreciate that other platforms, such as an IA-64, available from Intel Corporation, an M68K, available from Motorola, Inc., or an MIPS 32/64, available from MIPS Technology, Inc. may be used in certain embodiments. The WTCP is a software module that may include a kernel process running in the GNU/Linux operating system.

An interface, for example, a graphical user interface, which may be implemented as a dynamic link library, permits access to the WTCP features. The WTCP is mainly a kernel behavior of an operating system. That is, setting kernel parameters can control the functionality, performance and behavior of the WTCP. The primary method to access these parameters can be reached by modifying the source code of the WTCP on the GNU/Linux operating system before compiling. The features of the WTCP can be accessed through a GNU/Linux virtual file-system during the run-time. In an alternative embodiment, the features of WTCP can be accessed through a standalone GUI-based program.

The WTCP includes algorithms that are computation-intensive so that a preferred embodiment of the WTCP server 16 includes a powerful microprocessor. For example, because of the capability of multiprocessors as well as the processing power, the Pentium® 4 Xeon Series, which is commercially available from Intel Corporation, is used in one embodiment of the WTCP server 16. The processor and core logic are preferably chosen to deliver high computing performance and memory throughput.

The WTCP server 16 includes memory devices that store programs and data, and interact with the processor. The memory devices include SDRAMs that are synchronized to the system clock. It is contemplated that memory devices may include other kinds of memory typically used in conventionally used, e.g. RDRAM or DDR-SDRAM.

The system (or the WTCP server 16) is configured for load balancing and content switching. In content switching, traffic is intelligently load balanced across servers in a data center or a point of presence (POP) based on the availability of the content and the load on the server. The content switching is performed by a content switch, which is a “smart” switch with sophisticated load-balancing capabilities and content-acceleration intelligence. The content switch operates as a load balancer for “heavy-duty” applications, such as web hosting, wherein the load balancer functions as a “traffic police” or “Director” that monitors the main entrance of all processing routes. The load balancer's goal is to distribute the traffic load across multiple servers as fair as possible. With respect to the WTCP server 16, the load-balancer is an external, frond-end equipment that is transparent to the WTCP GNUI/Linux platform. A load balancer is commercially available, for example, from Coyote Point Systems, Inc., Cisco Systems, Inc., and IPivot, Inc.

In one embodiment, the system 1 includes a Cisco Catalyst 6500 Series Content Switching Module. The Cisco Content Switching Module (CSM) is a Catalyst® 6500 line card that is configured as a load balancer. The CSM provides a high-performance, cost-effective load balancing solution for enterprise and Internet service provider (ISP) networks. The CSM meets the demands of high-speed content delivery networks, tracking network sessions and server load conditions in real time and directing each session to the most appropriate server. Fault tolerant CSM configurations maintain full state information and provide true hitless fail-over required for mission-critical functions.

The system 1 described herein provides for a TCP-WTCP protocol translation. An example for such a protocol translation is described hereinafter with respect to a video clip available via the Internet 20 from the host server 22. That is, the host server 22 shown in FIG. 1 pushes a video clip to one of the terminals 8, 10. The application in the host server 22 sends a video stream to the local TCP that breaks the video stream into packets and sends the packets over the Internet 20 to the WTCP server 16. Before packets arrive at the WTCP server 16, the packets pass through the router 18. The router provides the functions of traffic aggregation and an optional firewall, but does not perform protocol translation.

The software in the WTCP server 16 implements a set of algorithms on various layers of the OSI reference model. A packet arriving at the WTCP server 16 is forwarded to the TCP layer, as indicated in the intermediate node 28 shown in FIG. 2. If necessary, the packet is buffered. The WTCP server 16 tags the WTCP header and performs fragmentation according to the size of a maximum transport unit. In one embodiment, the “TCP side” of the WTCP server 16 has a maximum transport unit size of 1500 bytes, and the “WTCP side” of the WTCP server 16 has a maximum transport unit size of 576 bytes. In one embodiment, the WTCP side of the network may be slower than the TCP side since a CDMA network is circuit oriented in nature while the Internet is broadband oriented in nature. Buffering and fragmentation occurs in the WTCP server 16.

After the packet leaves the WTCP server 16, the packet passes through the PDSN 14 that provides for a generic routing encapsulation (GRE) header to take care of the mobility in the cellular network. When the PCF node 12 receives the packet, the PCF node 12 further fragments the packet into frames with a duration of 20 milliseconds and delivers the frames to the BSC 4 and the BTS 6. The BTS 6 converts the data packet and its frames to an RF signal for wireless transmission to a terminal 8, 10.

When the terminal 8, 10 receives the RF signal, the terminal 8, 10 performs a frame re-assembly to reconstruct the data frame transmitted by the PCF node 12. The frame and the data contained therein are then further processed by “higher” layers. For example, the layer 2 receives a point-to-point frame for termination. Note that the PDSN 14 added a point-to-point header. Further, the WTCP client strips off the WTCP header and delivers the packet to the application running in the terminal 8, 10.

In a reverse direction, i.e., from a terminal 8, 10 to the host server 22, the system 1 provides for substantially the same procedure. That is, it is contemplated that the WTCP server 16 performs a WTCP-TCP translation that corresponds to the TCP-WTCP translation.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A wireless communication system comprising:
a first branch configured for communications between a wireless terminal and a telecommunication device coupled to a first network;
a second branch configured for data communications between the wireless terminal and a host server coupled to a second network, the second branch comprising:
a first network element coupled to receive data signals from the wireless terminal and to send data signals to the wireless terminal;
a router coupled to the second network; and
a server coupled between the router and the first network element, the server configured to translate a first transmission protocol used for communications over the second network to a second transmission protocol used for communications with the wireless terminal.

2. The system of claim 1, wherein the first network is a public switched telephone network.

3. The system of claim 1, wherein the second branch is configured for packet-switched transmission.

4. The system of claim 3, wherein the first network element is a packet data serving node.

5. The system of claim 1, wherein the first and second branches are configured for communications in accordance with a code division multiple access technology.

6. The system of claim 1, wherein the second network is the Internet.

7. The system of claim 6, wherein the first transmission protocol is a transmission control protocol (TCP) defined for Internet applications, and wherein the second transmission protocol is a wireless transmission control protocol (WTCP).

8. The system of claim 7, wherein the server is configured to receive a data packet from the Internet and to divide the data packet into a predetermined number of different classes to generate a transmit queue for each class, wherein each class represents a wireless terminal.

9. The system of claim 8, wherein the server is further configured to prioritize the classes for transmission to the wireless terminals.

10. A method of transmitting data signals between a wireless terminal and a host server coupled to the Internet, comprising:
receiving data at a server interposed between a router coupled to the Internet and a first network element coupled to communicate with a wireless terminal;
upon receipt of data sent by the router, translating a first transmission protocol used for communications over the Internet to a second transmission protocol used for communications with the wireless terminal; and
upon receipt of data sent by the first network element, translating the second transmission protocol to the first transmission protocol.

11. The method of claim 10, wherein the act of translating the first transmission protocol to the second transmission protocol includes dividing an incoming packet into a predetermined number of classes of packets, wherein each class represents a wireless terminal.

12. The method of claim 11, wherein the act of translating the first transmission protocol to the second transmission protocol includes prioritizing the classes of packets for transmission to wireless terminals.

13. The method of claim 10, wherein the act of translating the first transmission protocol to the second transmission protocol includes entering into a modified slow start procedure in which a used bandwidth increases to about 25% within a predetermined time.

14. The method of claim 10, wherein the act of translating the first transmission protocol to the second transmission protocol includes entering into a modified congestion avoidance mode in which a used bandwidth is maintained between about 100% and about 75%.

15. A method of transmitting data signals between a wireless terminal and a host server coupled to the Internet, comprising:
sending data from a host server via the Internet to a router using a first communications protocol;
forwarding the data from the router to a server coupled between the router and a first network element; and
translating the first transmission protocol used for communications over the second network to a second transmission protocol used for communications with the wireless terminal.
